(19) United States
(12) Patent Application Publication
(10) Pub. No.: US 2015/0096524 A1
(43) Pub. Date: Apr. 9, 2015

(54) PISTON FOR AN INTERNAL COMBUSTION ENGINE

(71) Applicants: Ulrich Bischofberger, Esslingen (DE); Stefan Gaiselmann, Stuttgart (DE)

(72) Inventors: Ulrich Bischofberger, Esslingen (DE); Stefan Gaiselmann, Stuttgart (DE)

(73) Assignee: MAHLE International GmbH, Stuttgart (DE)

(21) Appl. No.: 14/398,786

(22) PCT Filed: May 3, 2013
(86) PCT No.: PCT/DE2013/000240

§ 371 Date: Nov. 4, 2014

(30) Foreign Application Priority Data
May 5, 2012 (DE) 10 2012 008 946.5

(51) Int. Cl. F02F 3/04; F02F 3/00

(52) U.S. Cl. CPC F02F 3/04; F02F 3/0084
USPC 123/193.6

(57) ABSTRACT

The invention relates to a piston for an internal combustion engine made of an iron-based material, comprising a piston head and a piston skirt, the piston head comprising a piston base, a peripheral top land and a peripheral annular part comprising annular grooves. According to the invention, at least one annular groove comprises at least one insert made of an zinc-based material.

The present invention relates to a piston of an internal combustion engine, made from a material based on iron, having a piston head and a piston skirt, wherein the piston head has a piston crown, a circumferential top land, and a circumferential ring belt comprising ring grooves.

In modern internal combustion engines, particularly diesel engines, the problem exists that the exhaust gases formed during the combustion process can develop a corrosive effect. This particularly relates to pistons made from an iron-based material, for example a steel material. The ring grooves of such a piston, in particular, are subject to additional wear because of such corrosive attack. As a result, they—together with the piston ring accommodated in them—prematurely lose their function of providing a seal relative to the combustion space on the piston crown side.

From WO 03/025365 A1, it is known to provide a piston made from an iron-based material with a corrosion protection layer on the basis of nickel, which layer is deposited in non-electrical manner. It is a disadvantage, in this connection, that such protective layers are prematurely worn away by abrasion in the region of the ring grooves, during engine operation, and thereby lose their corrosion-protection effect. Furthermore, the application of such protective layers, with a thickness of more than 3 μm, is too cost-intensive for series production.

The task of the present invention consists in further developing a piston of the stated type in such a manner that effective corrosion protection is obtained in the region of at least one ring groove, with the most simple means possible.

The solution consists in the fact that at least one ring groove has at least one insert made from a material based on zinc.

The at least one insert provided according to the invention acts as a sacrificial anode in a corrosive environment, i.e. the at least one insert provided according to the invention is oxidatively attacked in a corrosive environment. In this connection, the piston material is spared any corrosive attack, because it, as an iron-based material, is more positive in the electrochemical series than the zinc-based material of the at least one insert provided according to the invention. The corrosion protection brought about in this way can be maintained until the material of the at least one insert has been completely oxidized.

The at least one insert provided according to the invention thereby makes it possible to introduce individually configured corrosion protection, in accordance with the requirements of an individual case, into the at least one ring groove of the piston according to the invention. Not only the position of the at least one insert according to the invention but also the amount of the zinc-based material can be optimally adapted to the operating conditions during engine operation. If necessary, the at least one ring groove can be configured with a greater depth than usual, in order to be able to accommodate the at lest one insert according to the invention, without influencing the position of the piston ring with reference to the cylinder working surface in the finished, assembled engine.

Furthermore, it is advantageous that the corrosion protection brought about by the at least one insert provided according to the invention is not restricted just to the region of the ring groove that stands in direct contact with the insert. Instead, it is observed that the immediate vicinity of the insert, up to a distance of several millimeters, is also covered by this corrosion protection. For this reason, the region to be protected does not have to stand in direct contact with the insert provided according to the invention, in its entirety. It is completely sufficient to dimension the at least one insert so that the corrosion-protection effect essentially covers the ring groove, and that enough zinc-based material is available for the lifetime of the piston during engine operation, so that the piston material itself is not corrosively attacked.

Advantageous further developments are evident from the dependent claims.

The insert provided according to the invention can be configured in one piece and can be loosely laid into the at least one ring groove. In this case, it is advantageous if the insert provided according to the invention stands under a certain bias, so that a firm hold in the ring groove is guaranteed, before the piston ring is inserted into the ring groove.

The at least one insert provided according to the invention can also be attached to the groove bottom of the at least one ring groove, particularly by means of gluing, welding, or rolling.

The at least one insert provided according to the invention is preferably configured in the form of a strip or wire, and can have a circular, oval, square or rectangular cross-section, for example.

The material of the at least one insert provided according to the invention should preferably contain at least 50 wt.-% zinc. However, it can also consist of pure zinc. The zinc proportion in the material of the insert provided according to the invention is essentially dependent on the zinc demand during engine operation, i.e. on the scope of the required corrosion protection during engine operation.

Preferably, the uppermost ring groove, i.e. the ring groove adjacent to the piston crown, which accommodates the compression ring, is provided with at least one insert according to the invention.

An exemplary embodiment of the present invention will be explained in greater detail below, using the attached drawings. These show, in a schematic representation, not true to scale:

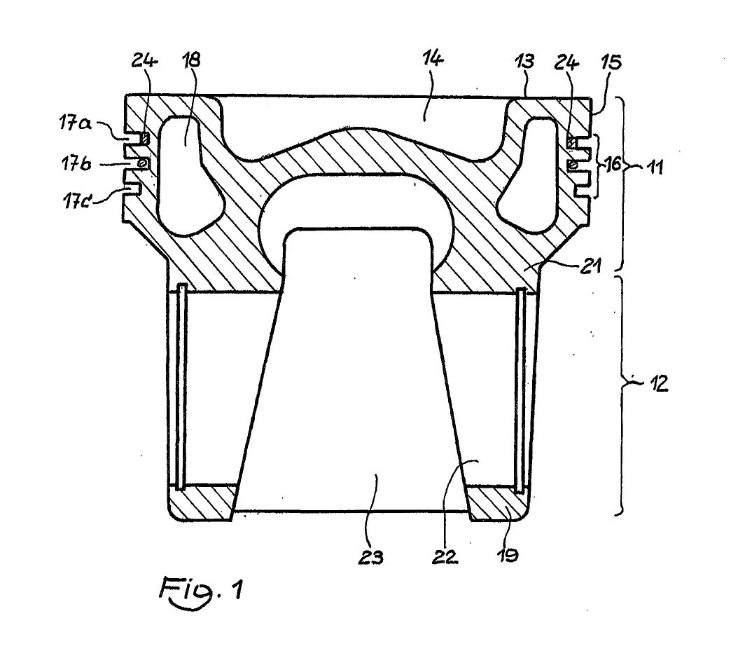

FIG. 1 a first exemplary embodiment of a piston according to the invention, in section;

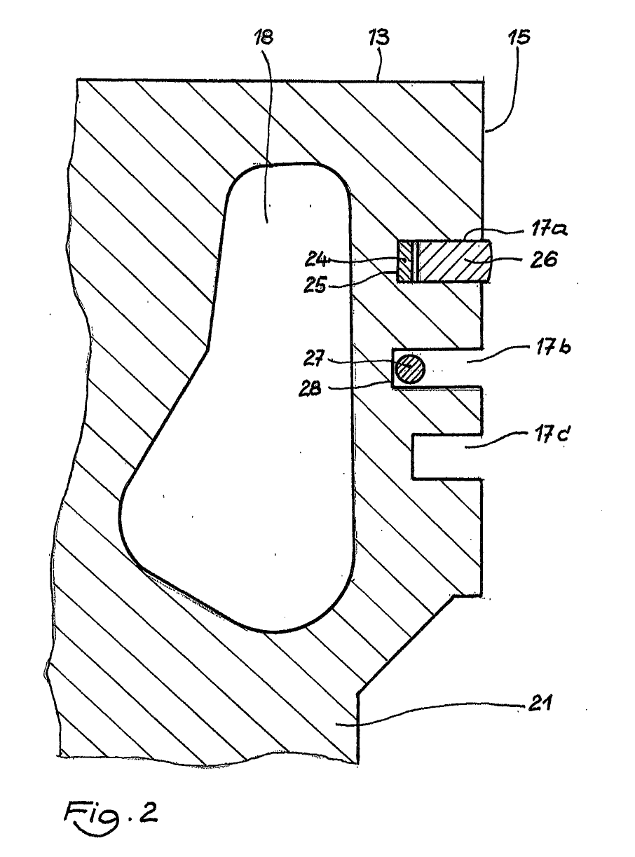

FIG. 2 the piston according to FIG. 1 in an enlarged partial representation, in section.

FIG. 1 shows an exemplary embodiment of a piston 10 according to the invention. In the exemplary embodiment, the piston 10 is a one-part box piston and has a piston head 11 and a piston skirt 12. The piston 10 can be produced from a material on the basis of cast iron or steel, for example. The piston according to the invention can, of course, also be configured as a multi-part piston.

The piston head 11 has a piston crown 13 having a combustion bowl 14 as well as a top land 15 and a circumferential ring belt 16 having ring grooves 17a, 17b, 17c for accommodation of piston rings. Furthermore, a circumferential closed cooling channel 18 is formed between the combustion bowl 14 and the ring belt 16.

The piston skirt 12 has pin bosses 19, in known manner, which are connected with the underside of the piston head 11 by way of pin boss connections 21. The pin bosses 19 are provided with pin bores 22 for accommodation of a piston pin (not shown). The pin bosses 18 are connected with one another in known manner, by way of working surfaces 23.

As can be derived from FIGS. 1 and 2, the uppermost ring groove 17a is provided with a first insert 24. In the exemplary embodiment, the insert 24 is configured as a one-part ring and has a rectangular cross-section. The insert 24 consists of pure zinc, but can also consist of a zinc alloy having at least 50 wt.-% zinc. In the exemplary embodiment, the insert 24 is attached to the groove bottom 25 of the uppermost ring groove 17a by means of spot welding or a rolling-in process. Of course, multiple smaller inserts can also be provided, distributed in the ring groove 17a.

To elucidate the present invention, the compression ring 26, which is accommodated in the uppermost ring groove 17a in the finished, assembled piston 10, is shown in FIG. 2.

In the present exemplary embodiment, a second insert 27 is accommodated in the second ring groove 17b, whereby in this case, the piston ring was not shown. In the exemplary embodiment, the insert 27 is configured as a one-part wire ring and has a circular cross-section. The insert 27 consists of pure zinc, but can also consist of a zinc alloy having preferably at least 50 wt.-% zinc. In the exemplary embodiment, the insert 27 lies against the groove bottom 28 of the second ring groove 17b with bias. Of course, multiple smaller inserts can also be provided, distributed in the ring groove 17b and attached to the groove bottom 28.

1. Piston (10) for an internal combustion engine, made from a material based on iron, having a piston head (11) and a piston skirt (12), wherein the piston head (11) has a piston crown (13), a circumferential top land (15), as well as a circumferential ring belt (16) comprising ring grooves (17a, 17b, 17c), wherein at least one ring groove (17a, 17b) has at least one insert (24, 27) made from a material based on zinc.

2. Piston according to claim 1, wherein the at least one insert (27) is configured in one piece and is loosely laid into the at least one ring groove (17b).

3. Piston according to claim 2, wherein the at least one insert (27) is laid into the at least one ring groove (17b) with bias.

4. Piston according to claim 1, wherein the at least one insert (24) is attached to the groove bottom (25) of the at least one ring groove (17a).

5. Piston according to claim 4, wherein the at least one ring insert (24) is rolled into the groove bottom (25) of the at least one ring groove (17a).

6. Piston according to claim 1, wherein the at least one insert (24, 27) is configured in the form of a strip or wire.

7. Piston according to claim 5, wherein the at least one insert (24, 27) has a circular, oval, square or rectangular cross-section.

8. Piston according to claim 1, wherein the material of the at least one insert (24, 27) contains at least 50 wt.-% zinc.

9. Piston according to claim 1, wherein the material of the at least one insert (24, 27) consists of pure zinc.

10. Piston according to claim 1, wherein at least the uppermost ring groove (17a) has at least one insert (24).
